(19) United States
(12) Patent Application Publication
(10) Pub. No.: US 2007/0181636 A1
(43) Pub. Date: Aug. 9, 2007

(54) Guide element, use of a guide element and method for the production of a guide element

(75) Inventors: August Stadlmayr, Desselbrunn (AT); Peter Lippert, Neukirchen (DE)

Correspondence Address: DICKINSON WRIGHT PLLC, 38525 WOODWARD AVENUE, SUITE 2000, BLOOMFIELD HILLS, MI, 48304-2970, US

(73) Assignee: FEDERAL-MOGUL DEVA GMBH, Stadtallendorf (DE)

(21) Appl. No.: 10/567,048

(22) PCT Filed: Jul. 23, 2004
(86) PCT No.: PCT/DE04/01662

§ 371 Date: Jun. 1, 2006

(30) Foreign Application Priority Data
Aug. 2, 2003 (DE) 103 35 452.2

(51) Int. Cl. A47J 36/02

(52) U.S. Cl. 228/101

(57) ABSTRACT

Disclosed is a guide element comprising a base body having at least two guide surfaces disposed on various non-parallel planes. In order to provide the guide surfaces disposed on various non-parallel planes with a sliding lining, the guide surfaces are provided with at least one pre-fabricated strip of material consisting of a carrier material and a sliding material placed thereon. The strips of said strip material are fixed to the base body by laser welding. According to the method for the production of one such guide element, strips of the strip material consisting of a carrier material and a sliding material placed thereon are pre-fabricated and the strip or strips is/are placed on a guide surface by means of laser welding.

### DESCRIPTION

The invention is in regard to a guide element with a base body having at least two guide surfaces disposed on various non-parallel planes. The invention is in regard to the use of such guide elements, and to a method for the production of the same.

Such guide elements are used, for example, in molds for manufacturing automotive tires, the so-called tire vulcanization molds, particularly those exhibiting a T-shaped profile. The two parts of the mold are moved back and forth during opening and closing, with T-shaped or hook-shaped elements for guidance.

This type of vulcanization mold is known from EP 0 250 708 B1 for molding vehicle tires. This includes radial molding segments for providing the shape, which are mounted in a fixed assembly to glide perpendicular to the opening/closing direction of the mold within the mold container for opening and closing. The bearing of the molding segments consists of each molding segment having a rail-like slide groove with parallel side walls, and each retaining ring of the mold container having a slide shoe corresponding to the slide rail. The slide shoe includes a guide element. This guide element, with a T-shaped profile, reaches from outside the slide rail into the slide rail, so that within the slide rail, the crosspiece of the T-shape is encompassed by the slide rail's side walls in order to secure the sliding guide's contact with the slide rail.

The guide element with a T-shaped profile has at least three parts, where a sliding strip is fixed between a spacer and a crosspiece. In the area of the sliding contact between the three-part guide element and the slide shoe, the sliding strip serves to reduce abrasion.

To assemble, the three separate parts of the T-shaped guide element are screwed together. Once the sliding strip has worn beyond the desired degree of abrasion, the parts can be unscrewed, the worn sliding strip can be replaced, and the parts can be reassembled with the new sliding strip. The cracks and areas of settling between the three parts, and between the parts and the screws, can lead to undesirable, undefined jamming and imprecision in the functioning of the mold segments, especially after heavy use. This can severely impact the molding accuracy and the useful life of the molding mechanism, This effect can be prevented to some degree by replacing all three parts at frequent intervals.

If only the sliding strip is replaced frequently, this will result in high, and in some cases undefined inaccuracies and jams, beginning from the installation of a new sliding strip, due to the previous abrasion between parts and screws, and this in the T-shaped guide element, which is critical to the accuracy of the closing/opening mechanism of the mold. Maintenance and operating errors during assembly and disassembly of the T-shaped guide element only increase this risk. In addition, only a small portion of the intricate, expensive sliding coating actually helps towards reducing wear, since a large portion of the coating surface is covered by the other two assembly parts.

In order to improve this situation, DE 198 22 338 proposed sintering a sliding material on the guide surface of the guide element, which consists of steel, at the radial interior surfaces of the crosspiece. These surfaces were coated by sintering with a lubricating material of a thickness of about 2 to 5 mm. Powdered Cu81Sn13C6F was used for this purpose.

In some molds, the lateral surfaces of the T-shaped guide element's vertical piece are also utilized as guide surfaces due to an additional swiveling movement as part of the opening and closing motion, so that these must also be treated as sliding surfaces.

If high-grade steel is used for the guide element's base body, additional coating is not needed in this area. However, wear is still relatively high, so that it would be desirable to apply a lubricating coating to these surfaces of the base body, as well.

Sintering a coating to these surfaces is extremely problematic, because it is not possible to apply the necessary pressure to the guide surfaces disposed in a different plane without a complicated change of tools.

It is the objective of the invention, therefore, to invent a guide element whose guide surfaces, disposed in several non-parallel planes, can receive a sliding coating in a simple way.

This objective is achieved by a guide element where the guide surfaces have at least one pre-fabricated strip applied to them, consisting of carrier material with a sliding material placed thereon.

No complex tools are needed to apply a prefabricated strip to the guide surfaces, as would be the case in the application of sintered material to guide surface that are disposed in various planes that are not parallel. The strip material ca be pre-fabricated economically in large quantities and then only needs to be cut into corresponding strips and applied to the guide surfaces.

The base body of such a guide element with gliding strips can be manufactured from more inexpensive material, preferably in one piece, because the wear and tear caused by the opposing motion is absorbed by the strip material.

The most advantageous method for applying the strips has been found to be laser welding, because in this way the assembly is hardly impacted by heat. The sliding coating is not damaged, especially if it consists of plastic or includes plastic parts, and the strips do not warp during laser welding, as would be the case under regular welding,

In the preferred case of a guide element with a T-shaped base body, at least the interior guide surfaces, which are disposed at right angles to each other, should be equipped with strips of sliding material.

According to one embodiment of the invention, each of the guide surfaces can be fitted with its own sliding strip. The manufacturing process can be further simplified by applying a single strip to two contiguous guide surfaces.

In the preferred case, the base body consists of structural steel (ST 37), and the carrier material is also steel or stainless steel.

In the preferred case, the strip's sliding material consists of sintering material.

Preferably, the sliding material consists of a copper-tin alloy, where it would be advantageous if the copper-tin alloy contains polytetrafluor ethylene (PTFE) and/or graphite as the solid lubricant. In general, a self-lubricating composite sliding material is provided by the highly resistant steel body with a bronze matrix ensuring low abrasion with its homogeneous solid lubricant dispersion, which is extremely suitable for guide elements. The solid lubricant can be finely dispersed or it can be present as agglomerated particles, and it is characterized by a laminar structure as well as low interfacial resistance between opposing molecular boundaries.

To facilitate the intake phase in dry-run operation, an additional graphite and/or PTFE feed coating with a thickness of 10 to 30 μm can be applied. In operations with conventional lubricants, the strip can also be oil-impregnated.

In the preferred case, the PTFE portion should be 8% to 10% of weight, especially 9% of weight.

The graphite portion preferably should be 6% to 12% of weight, especially 8% to 10% of weight.

The weight values are in reference to the matrix material, for example, the copper-tin material, which is assumed to be 100%.

One preferred application of such a guide element is in molds for manufacturing rubber tires, in particular, automotive tires, truck tires, or industrial tires.

The method for the production of a guide element consists of pre-fabricating a sliding strip consisting of a carrier material and a sliding material placed thereon, and then applying the strip(s) to the guiding surfaces by means of laser welding.

The strip can have a welding seam on all four edges, but in most cases, it is sufficient to laser weld at least one longitudinal edge and both end edges.

To simplify, the strip can be fabricated with at least two areas covered with sliding material, separated by an uncovered portion of carrier material, whereupon the strip is bent in this uncovered area in accordance with the direction, i.e. the plane, of the contiguous guide surfaces that are to be covered.

Embodiment examples of the invention are explained below in reference to the drawings.

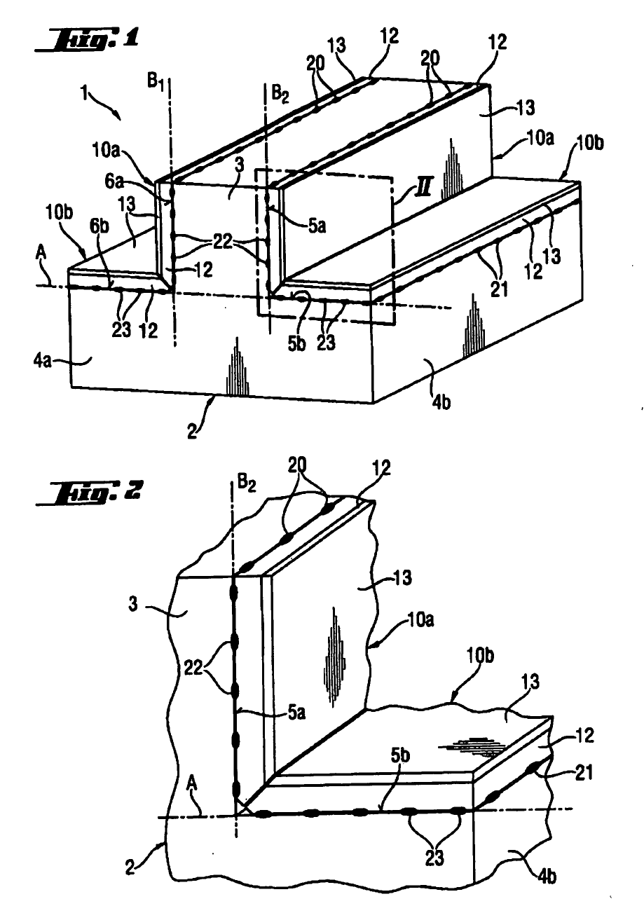

FIG. 1 shows a perspective representation of the T-shaped guide element;

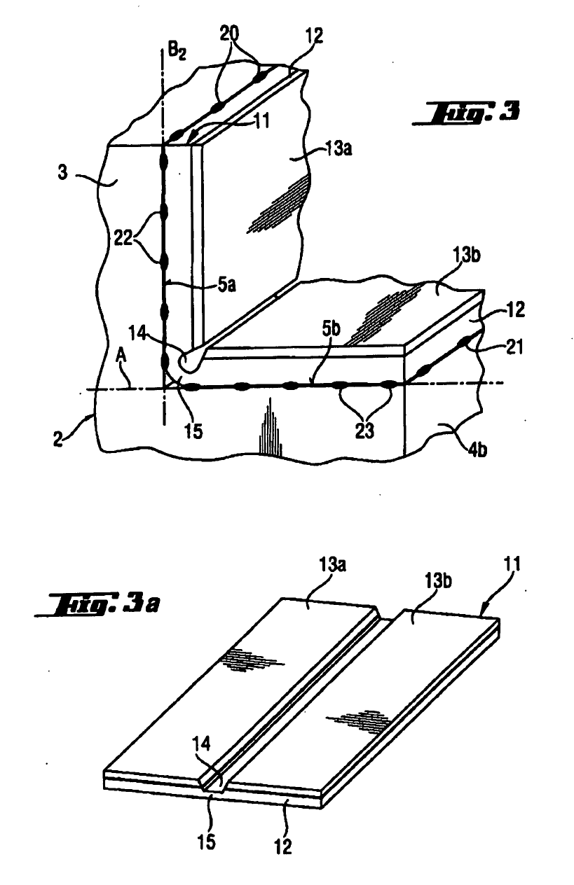

FIG. 2 shows an enlargement of Section II in FIG. 1;

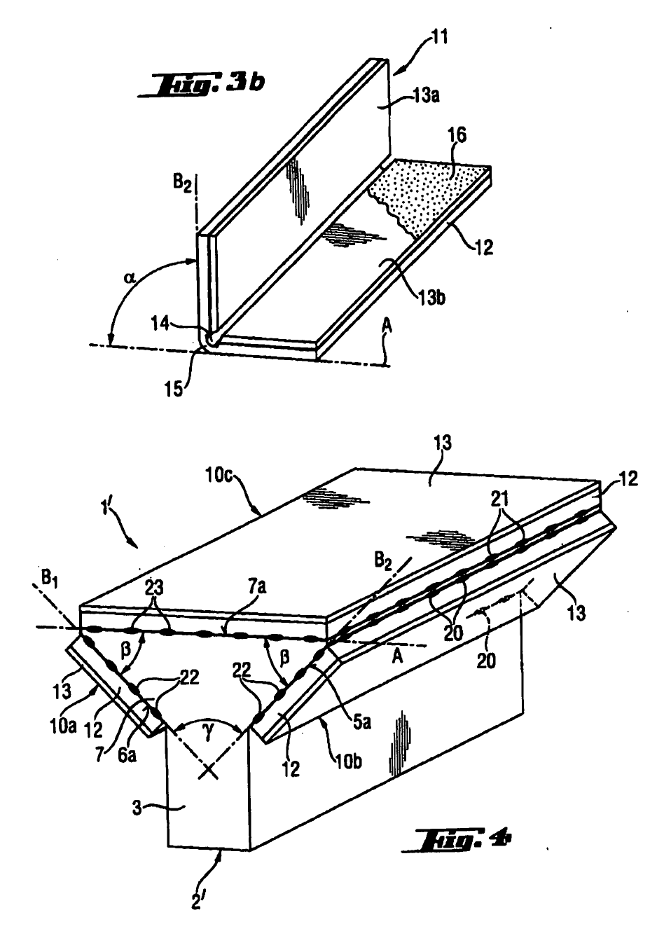

FIG. 3 shows an enlargement as in FIG. 2 of an additional embodiment;

FIGS. 3a+3b show the strip referenced in FIG. 3 being prepared; and

FIG. 4 shows a perspective representation of a guide element according to another embodiment.

FIG. 1 represents a guide element 1, comprising a single-unit base body 2 with a T-shaped profile, having a vertical piece 3, and a crosspiece with two horizontal flanges 4a, 4b. The guide surfaces 5a, 5b, and 6a, 6b are disposed on the interior of both the vertical piece 3 and the horizontal flanges 4a, 4b. The two guide surfaces 5b, 6b are disposed in the same plane A, while the guide surfaces 5a, 6a are disposed in two planes B₁ and B₂. The guide surfaces 5a, 5b, and 6a, 6b are each perpendicular to each other and are thus not disposed in the same plane.

Each guide surface 5a, 5b, 6a, 6b is covered with a strip 10a, 10b.

As shown in FIG. 2, the two strips 10a, 10b consist of a carrier material 12, which is affixed to the base body 2, and a coating of a sliding material 13, which is directly applied to the carrier material 12. In the area of the contiguous corners, the two strips are cut on the diagonal so that they are joined without gaps. Located along each of the two longitudinal edges of the strips are the laser welding seams 20, 21, and along the end edges, the laser welding seams 22 and 23. The laser welding seams are illustrated here as spot-welded by way of example. Naturally, the seam can also be welded continuously.

FIG. 3 illustrates another embodiment, where two guide surfaces 5a and 5b are perpendicular to each other and are covered with a strip 11. As represented in FIG. 3a, strip 11 exists initially as a flat strip, consisting of a carrier material 12, with sliding material covering one side, which is divided into two sections 13a, 13b by a free area on the carrier material 14. The free area 14 also reaches partway into carrier material 12, forming a bending zone 15. Before strip 11 is applied to guide element 1′, the initially flat strip 11 is first bent to a 90° angle α in bending zone 15 (s. FIG. 3b), so that the sliding material surfaces 13a and 13b form the functional surfaces at an open angle and can be welded to the base body 2′ by the carrier material 12 in planes A and B₁ along their longitudinal and end edges by means of laser welding 20, 21, 22, 23. In FIG. 3b, a so-called feed coating 16 is partially illustrated. This feed coating 16 can, of course, be included in all embodiment examples.

FIG. 4 illustrates another embodiment, where the guide element 1′ Y-shaped single-piece base body 2′ having a vertical piece 3 and V-shaped piece 7. In all, it comprises planes A, B₁ and B₂, form an angle β of 45° and an angle γ of 90°, with three guide surfaces 5a, 6a, 7a, covered respectively by the three strips 10b, 10c, with these strips also attached via laser welding (see FIG. 1).

The referred materials for the strips are listed in the following table:

Composition

| | | | Weight | | | |
|---|---|---|---|---|---|---|
| | | | in % | | | Solid Lubricant |
| # | Materials | Steel Back | Cu | Sn | Pb | % Weight |
| 1 | CuSn8713/9P | Niro²⁾ | 87 | 13 | | 9 |
| 2 | CuSn8713/6E | Niro | 87 | 13 | | 6 |
| 3 | CuSnPb8213/8E | Niro | 82 | 13 | 5 | 8 |
| 4 | CuSnPb8213/10pfE | Niro | 82 | 13 | 5 | 10 |
| 5 | CuSnPb8213/10pfE | unalloyed | 82 | 13 | 5 | 10 |
| 6 | CuSnPb8213/10pfE¹⁾ | unalloyed³⁾ | 82 | 13 | 5 | 10 |

¹⁾this strip material has a lubricating bore relief in the sliding coating
²⁾DIN 1.4301 or 1.4571
³⁾DIN 1.0338

The carrier material comprises a steel backing 12, consisting of stainless steel (Niro) or unalloyed steel. The proportions of weight specified for copper and tin and/or lead are in reference to the so-called matrix material, adding up to 100% weight.

The portion of weight for the solid lubricant percentage is specified in regard to this 100%.

### Reference Codes

1, 1′ guide element
2, 2′ base body
3 vertical piece
4a, 4b horizontal piece
5a, 5b guide surface
6a, 6b guide surface
7 V-shaped piece
7a guide surface
10a, 10b, 10c strips
11 strips
12 carrier material
13 sliding material
13a, 13b sliding material surfaces
14 free area
15 bending zone
16 feed coating
20 welding seam
21 welding seam
22 welding seam
23 welding seam
A plane
B₁ plane
B₂ plane
α angle
β angle
γ angle

1. A guide element with a base body having at least two guide surfaces disposed on different non-parallel planes characterized by
the guide surfaces having a pre-fabricated strip applied to them, consisting of carrier material with a sliding material placed thereon.

2. A guide element according to claim 1, characterized by the strip having been applied to the base body by means of laser welding.

3. A guide element with a T-shaped base body according to claim 1 respectively, characterized by at least the interior guide surfaces, which are disposed at right angles to each other, having strips.

4. A guide element according to claim 1 characterized by each of the guide surfaces having its own strip.

5. A guide element according to claim 1 characterized by each two contiguous guide surfaces, which are disposed on different planes, having one common strip.

6. A guide element according to claim 1 characterized by the base body consisting of structural steel, and the carrier material also consisting of steel or stainless steel.

7. A guide element according to claim 1 characterized by the sliding material consisting of a sintering material.

8. A guide element according to claim 1 characterized by the sliding material consisting of a copper-tin alloy.

9. A guide element according to claim 8 above, characterized by the copper-tin alloy containing PTFE and/or graphite.

10. A guide element according to claim 9 above, characterized by the PTFE portion amounting to 8% to 10% of weight.

11. A guide element according to claim 9, characterized by the graphite portion amounting to 6% to 12% of weight.

12. A guide element according to claim 1, characterized by the sliding material having a running-in layer.

13. Use of a guide element according to claim 1, for molds used in the manufacturing of rubber tires.

14. Use of a guide element according to claim 1 for molds used in the manufacturing of automotive tires, truck tires, or industrial tires.

15. A method for the production of a guide element with a base body having at least two guide surfaces disposed on various non-parallel planes, characterized by
the fact that at least one strip consisting of a carrier material with a sliding material placed thereon is pre-fabricated, and
the fact that the strip(s) is(are) applied to a guide surface by means of laser welding.

16. A method according to claim 15, characterized by the fact that the strip is laser welded along at least one longitudinal edge as well as both end edges.

17. A method according to claim 15, characterized by the fact that the strip is fabricated with at least two sliding material areas, which are divided by an uncoated area on the carrier material, and
the fact that the strip is bent in the uncoated area to correspond to the planes of contiguous guide surfaces to be covered by the strip.
